(19) United States
(12) Patent Application Publication
(10) Pub. No.: US 2005/0038806 A1
(43) Pub. Date: Feb. 17, 2005

(54) Methods and apparatus for detecting data race conditions in message-based multi-threaded programs

(76) Inventor: Zhiqiang Ma, Champaign, IL (US)

Correspondence Address: GROSSMAN & FLIGHT LLC, Suite 4220, 20 North Wacker Drive, Chicago, IL, 60606-6357, US

(21) Appl. No.: 10/639,216

(22) Filed: Aug. 12, 2003

(51) Int. Cl. G06F 17/00

(52) U.S. Cl. 707/102

(57) ABSTRACT

Methods and apparatus for detecting data race conditions in message-based multi-threaded programs are disclosed. The disclosed techniques monitor the creation of new threads, intercept message passing between threads and trace memory data access by each thread. When a new thread is created, a new clock vector is initialized and existing clock vectors are updated. Each time a thread sends a message to another thread, a message envelope which includes the original message is assembled and the clock vectors are updated. Each time a thread receives a message envelope from another thread, the message envelope is disassembled. If the message was sent synchronously, a reply envelope is sent. Again, clock vectors are updated. When a thread reads or writes a data location, the system checks if the same data location was accessed by another thread. If so, the clock for the other thread in the clock vector of the current thread and a recorded access time are checked to determine if a data race condition exists.

### TECHNICAL FIELD

The present disclosure pertains to multi-threaded computing systems and, more particularly, to methods and apparatus for detecting data race conditions in message-based multi-threaded programs.

### BACKGROUND

A message-based multithreaded program is a program in which one thread can pass a message to another thread to exchange data or to synchronize with each other. In such a program, messages may be passed synchronously or asynchronously. If a message is passed synchronously, the sending thread is blocked after the message is sent until the message has been received by the receiving thread; and the receiving thread is blocked until it has received the message. If a message is passed asynchronously, the sending thread is not blocked but continues to execute after the message is sent; the receiving thread is blocked until it has received the message. In other words, the receiving thread is blocked in both synchronous message passing and asynchronous message passing and the sending thread is blocked in synchronous message passing but non-blocked in asynchronous message passing. Hence, we also call blocked message sending in synchronous message passing as synchronous message sending and non-blocked message sending in asynchronous message passing as asynchronous message sending. In a message-based multithreaded program, data races can occur. A data race occurs when two threads access the same data concurrently and at least one thread accesses the data for writing. If a data race goes undetected, a computational error may occur without being known.

### BRIEF DESCRIPTION OF THE DRAWINGS

FIG. 1 is a block diagram of an example computer system illustrating an environment of use for the disclosed system.

FIG. 2 is a more detailed block diagram of the example computer system illustrated in FIG. 1.

FIG. 3 is a block diagram of another example computer system illustrating an environment of use for the disclosed system.

FIG. 4 is a block diagram of an example logical clock vector.

FIG. 5 is a block diagram of an example message envelope.

FIG. 6 is a block diagram of three example message envelopes of different types.

FIG. 7 is a flowchart representative of example machine readable instructions which may be executed by a device to implement the thread creation monitor and logical clock initializer of FIG. 3.

FIG. 8 and FIG. 9 are a flowchart representative of example machine readable instructions which may be executed by a device to implement the message sending interceptor of FIG. 3.

FIG. 10 and FIG. 11 are a flowchart representative of example machine readable instructions which may be executed by a device to implement the message receiving interceptor of FIG. 3.

FIG. 12 is a flowchart representative of example machine readable instructions which may be executed by a device to implement the data access tracer and race detector of FIG. 3.

### DETAILED DESCRIPTION

Generally, the methods and apparatus described herein monitor the creation of new threads, intercept message passing between threads and trace memory data access by each thread. When a new thread is created, a new clock vector is initialized and existing clock vectors are updated. Each time a thread sends a message to another thread, a message envelope which includes the original message is assembled and existing clock vectors are updated. Preferably, the message envelope is one of two types of predefined message envelopes dependant on whether the message is being sent synchronously or asynchronously. Each time a thread receives a message envelope from another thread, the message envelope is disassembled. If the message was sent synchronously, a reply envelope, which is a third type of predefined message envelope, is sent. Again, clock vectors are updated.

When a thread reads or writes a data location, the system checks if the same data location was accessed by another thread. If the same data location was accessed by another thread, the clock for the other thread in the clock vector of the current thread is compared to a recorded access time to determine if a data race condition exists. The system then records the identifier of the thread which is currently performing the memory data access and its own clock time in its clock vector as the memory data access time.

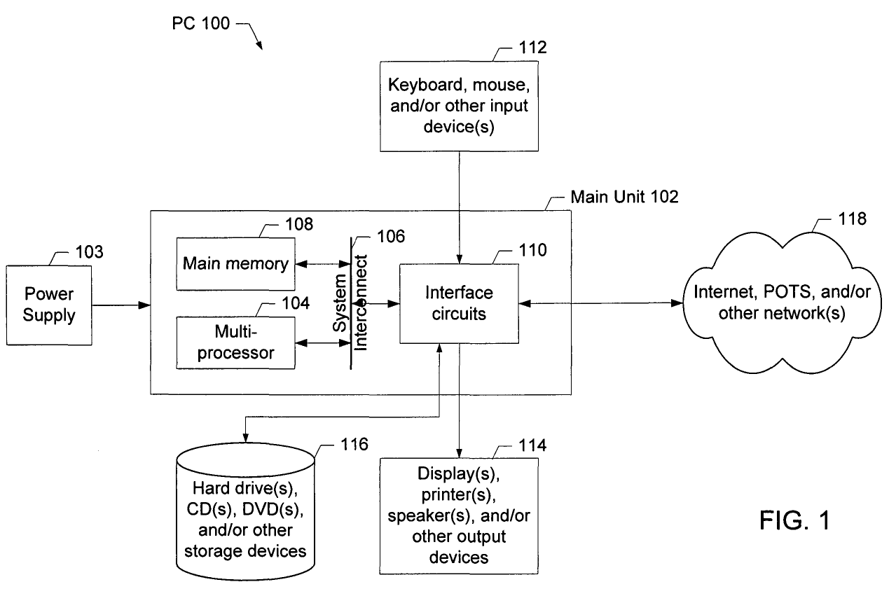

A block diagram of an example computer system 100 is illustrated in FIG. 1. The computer system 100 may be a personal computer (PC), a personal digital assistant (PDA), an Internet appliance, a cellular telephone, or any other computing device. In the example illustrated, the computer system 100 includes a main processing unit 102 powered by a power supply 103. The main processing unit 102 includes a processor 104 electrically coupled by a system interconnect 106 to a main memory device 108 and to one or more interface circuits 110. The processor 104 may be a single processor or a multi-processor unit. In an example, the system interconnect 106 is an address/data bus. Of course, a person of ordinary skill in the art will readily appreciate that interconnects other than busses may be used to connect the multi-processor unit 104 to the main memory device 108. For example, one or more dedicated lines and/or a crossbar may be used to connect the multi-processor unit 104 to the main memory device 108.

The processor 104 may include any type of well known processor, such as a processor from the Intel Pentium® family of microprocessors, the Intel Itanium® family of microprocessors, the Intel Centrino® family of microprocessors, and/or the Intel XScale® family of microprocessors. In addition, the processor 104 may include any type of well known cache memory, such as static random access memory (SRAM). The main memory device 108 may include dynamic random access memory (DRAM) and/or any other form of random access memory. For example, the main memory device 108 may include double data rate random access memory (DDRAM). The main memory device 108 may also include non-volatile memory. In an example, the main memory device 108 stores a software program which is executed by the processor 104 in a well known manner.

The interface circuit(s) 110 may be implemented using any type of well known interface standard, such as an Ethernet interface and/or a Universal Serial Bus (USB) interface. One or more input devices 112 may be connected to the interface circuits 110 for entering data and commands into the main processing unit 102. For example, an input device 112 may be a keyboard, mouse, touch screen, track pad, track ball, isopoint, and/or a voice recognition system.

One or more displays, printers, speakers, and/or other output devices 114 may also be connected to the main processing unit 102 via one or more of the interface circuits 110. The display 114 may be a cathode ray tube (CRT), a liquid crystal displays (LCD), or any other type of display. The display 114 may generate visual indications of data generated during operation of the main processing unit 102. The visual indications may include prompts for human operator input, calculated values, detected data, etc.

The computer system 100 may also include one or more storage devices 116. For example, the computer system 100 may include one or more hard drives, a compact disk (CD) drive, a digital versatile disk drive (DVD), and/or other computer media input/output (I/O) devices.

The computer system 100 may also exchange data with other devices via a connection to a network 118. The network connection may be any type of network connection, such as an Ethernet connection, digital subscriber line (DSL), telephone line, coaxial cable, etc. The network 118 may be any type of network, such as the Internet, a telephone network, a cable network, and/or a wireless network.

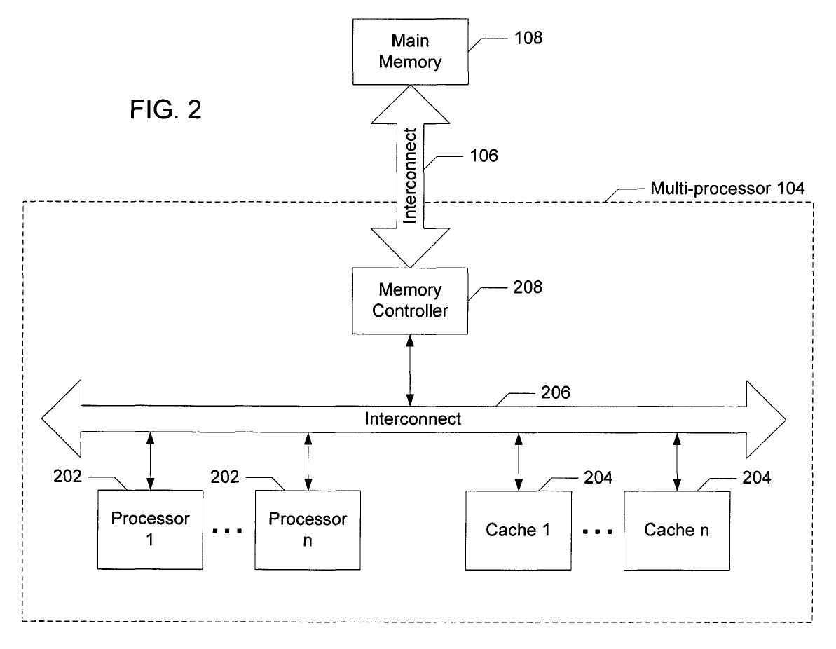

A more detailed block diagram of the example multi-processor unit 104 is illustrated in FIG. 2. The example multi-processor 104 shown includes one or more processing cores 202 and one or more caches 204 electrically coupled by an interconnect 206. Of course, a person of ordinary skill in the art will readily appreciate that a single core processor employing multi-threading may be used. The processor(s) 202 and/or the cache(s) 204 communicate with the main memory 108 over the system interconnect 106 via a memory controller 208.

Each processor 202 may be implemented by any type of processor, such as an Intel XScale® processor. Each cache 204 may be constructed using any type of memory, such as static random access memory (SRAM). The interconnect 206 may be any type of interconnect such as a bus, one or more dedicated lines, and/or a crossbar. Each of the components of the multi-processor 104 may be on the same chip or on separate chips.

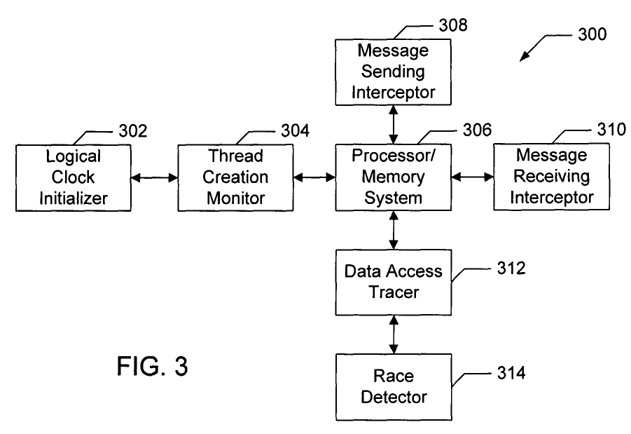

A block diagram of another example computer system 300 is illustrated in FIG. 3. In this example, the computer system 300 includes a logical clock initializer 302, a thread creation monitor 304, a processor/memory system 306, a message sending interceptor 308, a message receiving interceptor 310, a data access tracer 312, and a race detector 314 interconnected as shown. Preferably, the logical clock initializer 302, thread creation monitor 304, message sending interceptor 308, message receiving interceptor 310, data access tracer 312, and race detector 314 are implemented as one or more software routines which are stored and executed by the processor/memory system 306. However, a person of ordinary skill in the art will readily appreciate that one or more of these blocks may be implemented in hardware.

The thread creation monitor 304 monitors the processor/memory system 306 for the creation of new threads. For example, a first thread T1 may spawn a second thread T2. Of course, a person of ordinary skill in the art will readily appreciate that throughout this description, T1 and T2 are merely example threads. When a new thread is created, the logical clock initializer 302 creates a clock vector (e.g., a T2 clock vector) and initializes the new clock vector. In addition, the logical clock initializer 302 updates existing clock vectors (e.g., a T1 clock vector).

The message sending interceptor 308 intercepts a message (e.g., message M) being sent from a sending thread (e.g., thread T1) to a destination thread (e.g., thread T2). The message sending interceptor 308 then assembles a message envelope which includes the original message (e.g., message M). Preferably, the message envelope is one of two types of predefined message envelopes depending on whether the message is being sent synchronously or asynchronously. The message sending interceptor 308 then sends the message envelope to the destination thread. If the message is being sent synchronously, the message sending interceptor 308 also intercepts a reply envelope, a third type of predefined message envelope, being passed back from the destination thread (e.g., thread T2) to the original sending thread (e.g., thread T1). The reply envelope is then disassembled to recover an optional reply message (e.g., message R). The message sending interceptor 308 also updates the clock values in the clock vector of the sending thread (e.g., thread T1).

The message receiving interceptor 310 intercepts a message (e.g., message N) being received by a destination thread (e.g., thread T2) from a sending thread (e.g., thread T1). If the message is not one of two types of predefined message envelopes, the message receiving interceptor 310 simply delivers the message (e.g., message N) to the destination thread (e.g., thread T2). If the message is one of the predefined message envelopes, the message receiving interceptor 310 checks if the message envelope was sent synchronously or asynchronously, based on the type of the envelope. In either event, the message receiving interceptor 310 disassembles the message envelope (e.g., message N) in order to deliver a message payload (e.g., message M) to the destination thread. If the message was sent synchronously, the message receiving interceptor 310 also assembles an optional reply message (e.g., message R) in a reply envelope and sends the reply envelope to the original sending thread (e.g., thread T1) asynchronously. The message receiving interceptor 310 also updates the clock values in the clock vector of the destination thread (e.g., thread T2).

The data access tracer 312 and race detector 314 cooperate to trace memory data accesses (i.e., reads and writes) and detect race conditions. When a thread (e.g., thread T1) reads or writes a data location (e.g., data location X), the race detector 314 checks if the same memory data location was accessed by another thread (e.g., thread T2). If the same memory data location was accessed by another thread (e.g., thread T2), the race detector 314 compares the clock for the other thread (e.g., thread T2) in the clock vector of current thread (e.g., thread T1) with a recorded access time to determine if a data race condition exists. The data access tracer 312 then records the identifier of the thread (e.g., thread T1) which is currently performing the memory data access and its own clock time in its clock vector as the memory data access time.

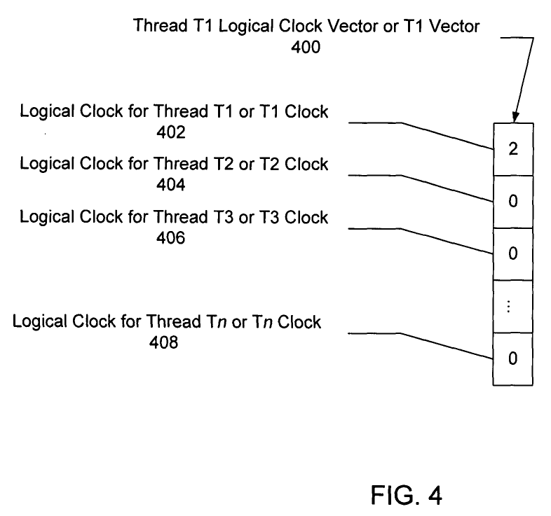

FIG. 4 is a block diagram of an example logical clock vector (e.g., T1 vector 400). The example logical clock vector 400 includes a logical clock for each of thread T1 (e.g., T1 clock 402), thread T2 (e.g., T2 clock 404), and thread T3 (e.g., T3 clock 406). Of course, the logical clock vector 400 may include a logical clock for any number of threads Tn (e.g., Tn clock 408). As described in the examples below, each logical clock in each logical clock vector holds a numerical value for that clock. In this example, T1 clock 402 has a value of “2”, and T2 clock 404 has a value of “0”. Of course, any type of values may be used.

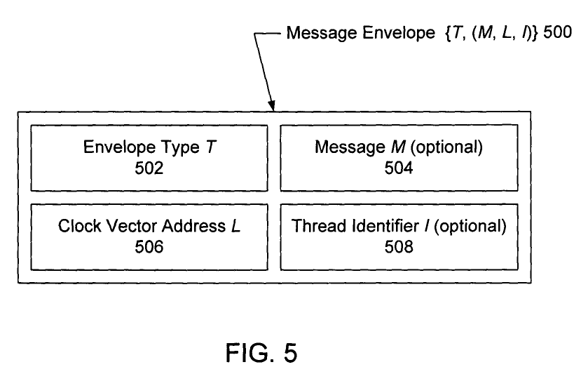

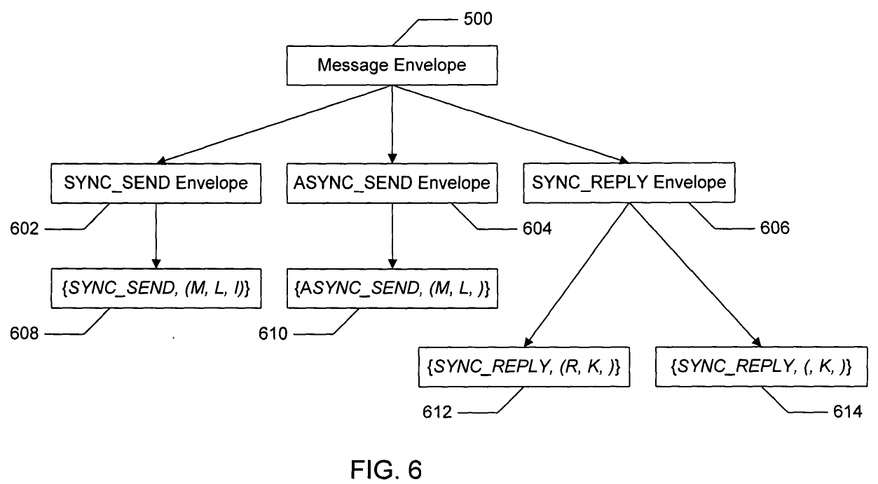

FIG. 5 is a block diagram of an example message envelope 500. In this example, the message envelope 500 includes an envelope type T 502, a message M 504, a clock vector address L 506, and a thread identifier I 508. The envelope type T 502 indicates what type of envelope is being sent/received. Various types of envelopes are described in detail below with reference to FIG. 6. The message M 504 is the payload of the message envelope 500. However, not all message envelopes are required to include a message. The clock vector address L 506 is a pointer to a logical clock vector (e.g., T1 clock vector 400). The thread identifier I 508 identifies the thread that is sending the message envelope (e.g., T2). As described below, the thread identifier I 508 may not be used by all message envelope types.

FIG. 6 is a block diagram of three example message envelopes of different types. The three types of message envelopes illustrated are a synchronous send message envelope 602, an asynchronous send message envelope 604, and a synchronous reply message envelope 606. Following the message envelope template described above with reference to FIG. 5, each of these message envelopes may include an envelope type T 502, a message M 504, a clock vector address L 506, and a thread identifier I 508.

The synchronous send message envelope 608 has a message type T 502 of “SYNC_SEND”. The synchronous send message envelope 608 includes a message M 504, a clock vector address L 506, and a thread identifier I 508.

The asynchronous send message envelope 610 has a message type T 502 of “ASYNC_SEND”. The asynchronous send message envelope 610 includes a message M 504 and a clock vector address L 506. However, the asynchronous send message envelope 610 does not include a thread identifier I 508.

A first type of synchronous reply message envelope 612 has a message type T 502 of “SYNC_REPLY”. This synchronous reply message envelope 612 includes a reply message R 504 and a clock vector address K 506. However, the synchronous reply message envelope 612 does not include a thread identifier I 508. A second type of synchronous reply message envelope 614 also has a message type T 502 of “SYNC_REPLY” and includes a clock vector address K 506. However, this synchronous reply message envelope 614 does not include a reply message R 504 or a thread identifier I 508.

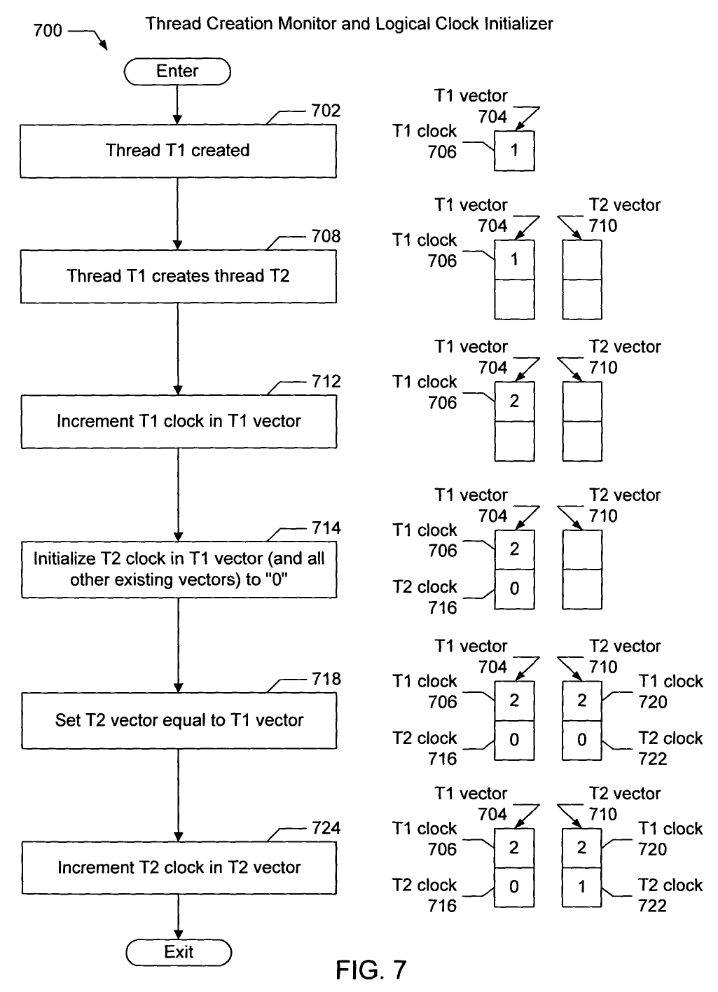

An example process 700 to implement the thread creation monitor 304 and logical clock initializer 302 is illustrated in FIG. 7. Preferably, the process 700 is embodied in one or more software programs which are stored in one or more memories and executed by one or more processors (e.g., processor 104) in a well known manner. However, some or all of the blocks of the process 700 may be performed by hardware. Although the process 700 is described with reference to the flowchart illustrated in FIG. 7, a person of ordinary skill in the art will readily appreciate that many other methods of performing the process 700 may be used. For example, the order of many of the blocks may be altered, the operation of one or more blocks may be changed, blocks may be combined, and/or blocks may be eliminated.

In general, the example process 700 monitors the creation of new threads. When a new thread (e.g., thread T2) is created by an existing thread (e.g., thread T1), a clock vector (e.g., T2 vector) for the new thread is created and initialized. In addition, existing clock vectors (e.g., T1 vector) are updated in response to the creation of the new thread.

The example process 700 begins when a first thread T1 is created (block 702). In response to the creation of thread T1, the process 700 creates a T1 clock vector 704. At this point, the T1 clock vector 704 has only one clock. Specifically, the T1 clock vector 704 has the T1 clock 706. In this example, the process 700 may initializes the T1 clock 706 to a value of 1.

Subsequently, thread T1 spawns a second thread e.g., T2 (block 708). In response to the creation of thread T2, the process 700 creates a T2 clock vector 710. In addition, the process 700 increments the T1 clock 706 in the T1 vector 704 (block 712). In this example, the T1 clock 706 in the T1 vector 704 is incremented from a value of 1 to a value of 2. In addition, the process 700 initializes the T2 clock in all existing vectors (block 714). In this example, the only existing vector is the T1 vector 704. Accordingly, the process 700 initializes the T2 clock 716 in the T1 vector 704 to a value of 0.

Subsequently, the process 700 sets the newly created T2 vector 710 equal to the creating thread T1's clock vector 704 (block 718). Specifically, a T1 clock 720 in the T2 vector 710 is set equal to the T1 clock 706 in the T1 vector 704. In this example, the T1 clock 720 in the T2 vector 710 is set to a value of 2. Similarly, a T2 clock 722 in the T2 vector 710 is set equal to the T2 clock 716 in the T1 vector 704. In this example, the T2 clock 722 in the T2 vector 710 is set to a value of 0.

Finally, the process 700 increments the newly created thread T2's clock 722 in the newly created T2 vector 710 (block 724). In this example, the value of the T2 clock 722 in the T2 vector 710 is incremented from a value of 0 to a value of 1.

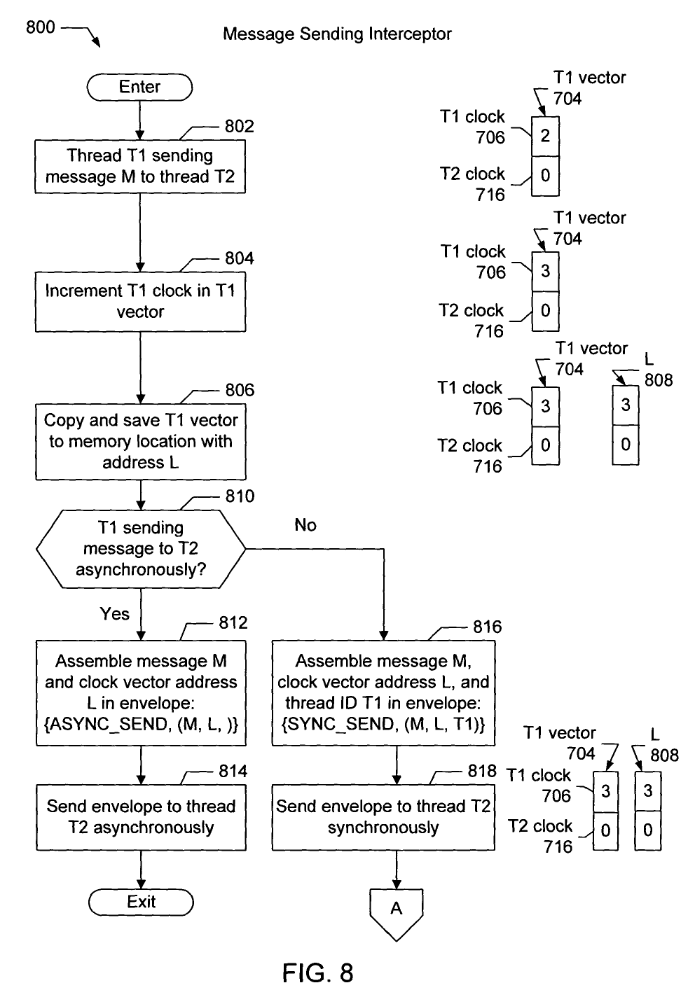

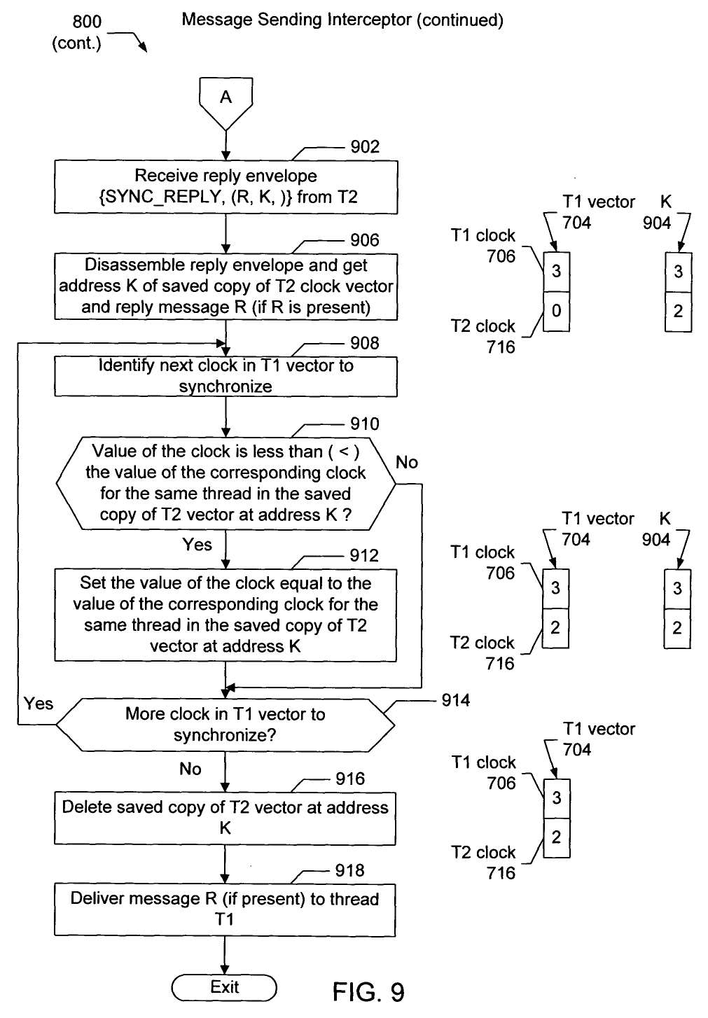

An example process 800 to implement the message sending interceptor 308 is illustrated in FIGS. 8-9. Preferably, the process 800 is embodied in one or more software programs which are stored in one or more memories and executed by one or more processors (e.g., processor 104) in a well known manner. However, some or all of the blocks of the process 800 may be performed by hardware. Although the process 800 is described with reference to the flowchart illustrated in FIGS. 8-9, a person of ordinary skill in the art will readily appreciate that many other methods of performing the process 800 may be used. For example, the order of many of the blocks may be altered, the operation of one or more blocks may be changed, blocks may be combined, and/or blocks may be eliminated.

In general, the example process 800 intercepts a message (e.g., message M) being sent from a sending thread (e.g., thread T1) to a destination thread (e.g., thread T2). If the destination thread and the sending thread are the same thread, the process 800 simply sends the original message to the destination thread. If the destination thread and the sending thread are not the same thread, the process 800 checks if the message is being sent is being sent synchronously or asynchronously. If the message is being sent asynchronously, the process 800 assembles one type of message envelope which includes the original message (e.g., message M) and sends the message envelope to the destination thread asynchronously. If the message is being sent synchronously, the process 800 assembles another type of message envelope which also includes the original message (e.g., message M) and sends that message envelope to the destination thread synchronously. In addition, if the message is being sent synchronously, the process 800 intercepts a reply envelope being passed back from the destination thread (e.g., thread T2) to the original sending thread (e.g., thread T1). The reply envelope is then disassembled to recover a reply message (e.g., message R), if a reply message is present. Throughout the process 800, the clock values in the clock vectors are updated.

The example process 800 begins when a sending thread T1 attempts to send a message M to a destination thread e.g., T2 (block 802). In response, the process 800 increments the T1 clock 706 in the T1 vector 704 (block 804). In this example, the process 800 increments the T1 clock 706 in the T1 vector 704 from a value of 2 to a value of 3. In addition, the process 800 makes a copy of the sending thread's clock vector and saves the copy to a memory location (block 806). In this example, a copy of the T1 vector 704 is saved to a memory location 808 with an address of L.

Next, the example process 800 checks if the message M is being sent synchronously or asynchronously (block 810). If the message M is being sent from thread T1 to thread T2 asynchronously, the process 800 assembles a message envelope which includes an asynchronous identifier (e.g., ASYNC_SEND), the original message M, and the address L of the copied vector 808 (block 812). Once the asynchronous envelope is assembled, the process 800 sends the envelope to the destination thread T2 asynchronously (block 814).

If the message M is being sent from thread T1 to thread T2 synchronously, the process 800 assembles a different message envelope which includes a synchronous identifier (e.g., SYNC_SEND), the original message M, the address L of the copied vector 808, and a thread identifier (e.g., T1) (block 816). Once the synchronous envelope is assembled, the process 800 sends the envelope to the destination thread T2 synchronously (block 818).

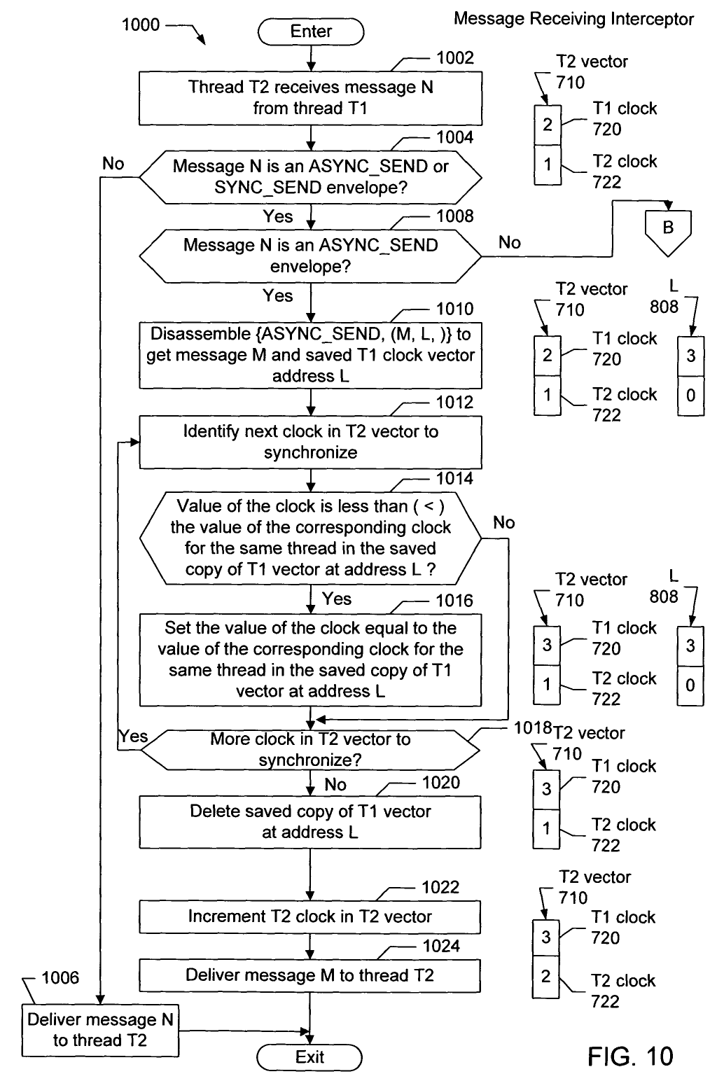

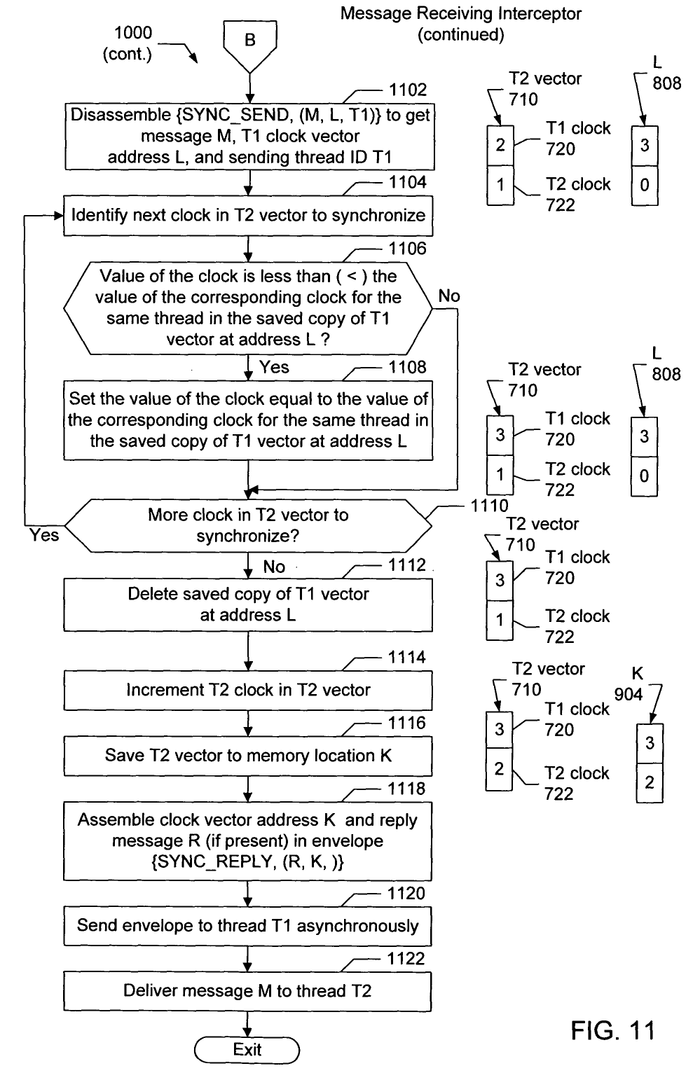

Turning to FIG. 9, thread T1 then receives a reply envelope from thread T2 (block 902). As described with reference to FIGS. 10-11 below, the reply envelope includes a synchronous reply identifier (e.g., SYNC_REPLY), a reply message R (if present), and an address K 904 of a saved copy of the T2 clock vector. Accordingly, the process 800 disassembles the reply envelope into its component parts (block 906).

Next, the process 800 synchronizes each clock in the sending thread T1's clock vector with the corresponding clock in the clock vector saved at address K. For each clock in the sending thread T1's clock vector (block 908), if the value is less than the value of the corresponding clock in the saved clock vector at address K (block 910), the clock in the sending thread T1's clock vector is set to the value of the corresponding clock in the saved clock vector at address K (block 912). Otherwise, the clock in the sending thread T1's clock vector is left unchanged. In this example, the T1 clock 706 in the T1 vector 704 is left unchanged, and the T2 clock 716 in the T1 vector 704 is set to a value of 2. Once all of the clocks in the sending thread T1's clock vector are synchronized (block 914), the saved clock vector at address K 904 may be deleted (block 916). Finally, the reply message R is delivered to the thread T1 if the reply message R is present (block 918).

An example process 1000 to implement the message receiving interceptor 310 is illustrated in FIGS. 10-11. Preferably, the process 1000 is embodied in one or more software programs which are stored in one or more memories and executed by one or more processors (e.g., processor 104) in a well known manner. However, some or all of the blocks of the process 1000 may be performed by hardware. Although the process 1000 is described with reference to the flowchart illustrated in FIGS. 10-11, a person of ordinary skill in the art will readily appreciate that many other methods of performing the process 1000 may be used. For example, the order of many of the blocks may be altered, the operation of one or more blocks may be changed, blocks may be combined, and/or blocks may be eliminated.

In general, the example process 1000 intercepts a message (e.g., message N) being received by a destination thread (e.g., thread T2) from a sending thread (e.g., thread T1). If the message is not one of two types of predefined message envelopes, the process 1000 simply delivers the message (e.g., message N) to the destination thread (e.g., thread T2). If the message is one of the predefined message envelopes, the process 1000 checks if the message envelope was sent synchronously or asynchronously, based on the type of the envelope. If the envelope is an ASYNC_SEND envelope, the message envelope was sent asynchronously. If the envelope is a SYNC_SEND envelope, the message was sent synchronously. In either event, the process 1000 disassembles the message envelope (e.g., message N) in order to deliver a message payload (e.g., message M) to the destination thread. If the message was sent synchronously, the process 1000 may also assemble a reply message (e.g., message R) in a reply envelope and send the reply envelope to the original sending thread (e.g., thread T1) asynchronously. Throughout the process 1000, the clock values in the clock vector of the destination thread (e.g., thread T2) are updated.

The example process 1000 begins when a destination thread T2 receives a message N from a sending thread T1 (block 1002). In response, the process 1000 checks if the message N is an ASYNC_SEND or a SYNC_SEND envelope (block 1004). If the message N is not an ASYNC_SEND or a SYNC_SEND envelope, the process 1000 delivers the message N to the destination thread T2 (block 1006). If the message N is an ASYNC_SEND or a SYNC_SEND envelope, the process 1000 determines if the message N is an ASYNC_SEND envelope (block 1008). If the message N is an ASYNC_SEND envelope, the process 1000 disassembles the message envelope N to retrieve a payload message M and an address L 808 (block 1010). Address L 808 is the address of a saved copy of thread T1's clock vector (see block 806 of FIG. 8).

Next, the process 1000 synchronizes each clock in the clock vector of the destination thread (e.g., thread T2) with the corresponding clock in the clock vector at address L. For each clock in the destination thread T2's clock vector (block 1012), if the value is less than the value of the corresponding clock in the saved clock vector at address L (block 1014), the clock in the destination thread T2's clock vector is set to the value of the corresponding clock in the saved clock vector at address L (block 1016). Otherwise, the clock in the destination thread T2's clock vector is left unchanged. Once all of the clocks in the destination thread T2's clock vector are synchronized (block 1018), the saved copy of the clock vector at address L 808 may be deleted (block 1020). In addition, the process 1000 increments the T2 clock 722 in the T2 vector 710 (block 1022). The payload message M is then delivered to the destination thread T2 (block 1024).

If the message N is not an ASYNC_SEND envelope (block 1008), the process 1000 disassembles the message envelope N to retrieve a payload message M, an address L 808, and a thread identifier T1 (block 1102). Again, address L 808 is the address of a saved copy of thread T1 's clock vector (see block 806 of FIG. 8).

Next, the process 1000 synchronizes each clock in the clock vector of the destination thread (e.g., thread T2) with the corresponding clock in the clock vector at address L. For each clock in the destination thread T2's clock vector (block 1104), if the value is less than the value of the corresponding clock in the saved clock vector at address L (block 1106), the clock in the destination thread T2's clock vector is set to the value of the corresponding clock in the saved clock vector at address L (block 1108). Otherwise, the clock in the destination thread T2's clock vector is left unchanged. Once all of the clocks in the destination thread T2's clock vector are synchronized (block 1110), the saved copy of the clock vector at address L 808 may be deleted (block 1112). In addition, the process 1000 increments the T2 clock 722 in the T2 vector 710 (block 1114).

Next, the process 1000 makes a copy of the destination thread T2's clock vector and saves the copy to a memory location (block 1116). In this example, the T2 vector 710 is saved to a memory location 904 with an address of K. Next, the example process 1000 assembles a reply message envelope which includes a synchronous reply identifier (e.g., SYNC_REPLY), an optional reply message R, and the address K of the saved copy of clock vector 904 (block 1118). Once the reply envelope is assembled, the process 1000 sends the envelope to the original sending thread T1 asynchronously (block 1120). In addition, the payload message M is delivered to the destination thread T2 (block 1122).

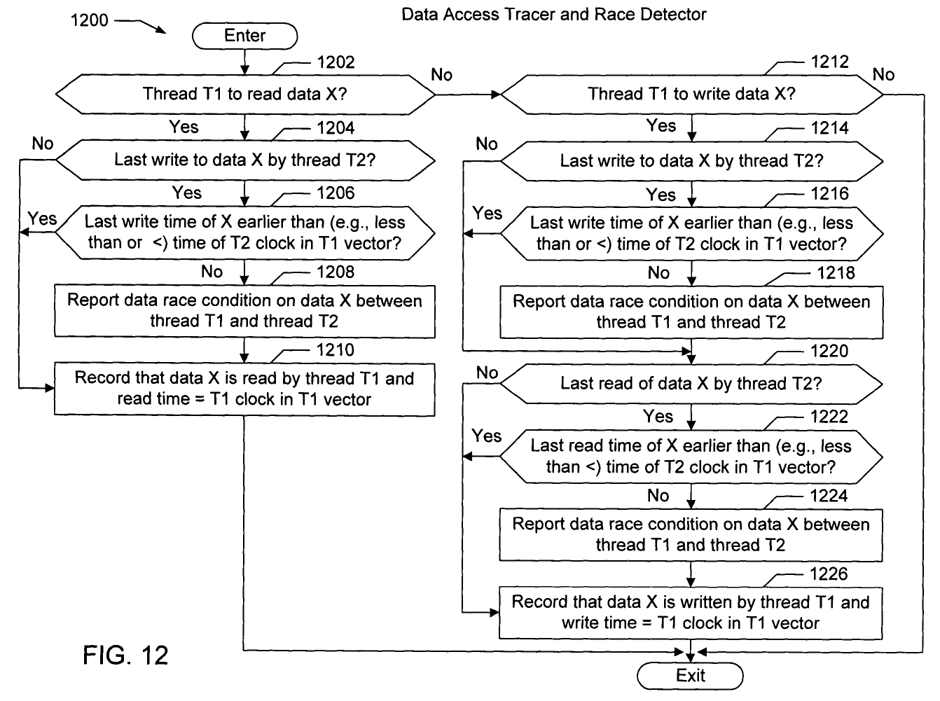

An example process 1200 to implement the data access tracer 312 and the race detector 314 is illustrated in FIG. 12. Preferably, the process 1200 is embodied in one or more software programs which are stored in one or more memories and executed by one or more processors (e.g., processor 104) in a well known manner. However, some or all of the blocks of the process 1200 may be performed by hardware. Although the process 1200 is described with reference to the flowchart illustrated in FIG. 12, a person of ordinary skill in the art will readily appreciate that many other methods of performing the process 1200 may be used. For example, the order of many of the blocks may be altered, the operation of one or more blocks may be changed, blocks may be combined, and/or blocks may be eliminated.

In general, the example process 1200 traces data access to detect race conditions. When a thread (e.g., thread T1) reads or writes a data location (e.g., data location X), the process 1200 checks if another thread (e.g., thread T2) was the last thread to access the data location. If another thread was the last thread to access the data location, the process 1200 checks the clock value for the another thread in the accessing thread vector and the recorded access time to determine if a data race condition exists. Then, in addition, the identifier of the accessing thread and the clock value for the accessing thread in the accessing thread vector are recorded as accessing thread and accessing time respectively.

The example process 1200 begins by determining if a thread (e.g., thread T1) is attempting to read a piece of data (e.g., data location X) (block 1202). If thread T1 is attempting to read data location X, the process 1200 checks if the last write to data location X was by another thread (e.g., T2) (block 1204). If the last write to data location X was by thread T2, the process 1200 determines if the time (i.e., the clock value) associated with the last write is not earlier than (e.g., greater than or equal to) the time recorded for the T2 clock 716 in the T1 vector 704 (block 1206). If the time associated with the last write is not earlier than (e.g., greater than or equal to) the time recorded for the T2 clock 716 in the T1 vector 704, the process 1200 reports a data race condition on X between thread T1 and thread T2 (block 1208). In any event, if thread T1 reads data location X, the process 1200 records the fact that T1 read data location X and records the value of the T1 clock 706 in the T1 vector 704 as the time of the read (block 1210).

If instead thread T1 is attempting to write data location X (block 1212), the process 1200 checks if the last write to data location X was by another thread T2 (block 1214). If the last write to data location X was by thread T2, the process 1200 determines if the time (i.e., the clock value) associated with the last write is not earlier than (e.g., greater than or equal to) the time recorded for the T2 clock 716 in the T1 vector 704 (block 1216). If the time associated with the last write is not earlier than (e.g., greater than or equal to) the time recorded for the T2 clock 716 in the T1 vector 704, the process 1200 reports a data race condition on X between thread T1 and thread T2 (block 1218). In any event, the process 1200 then continues to check if the last read of data location X was by another thread T2 (block 1220).

If the last read of data location X was by another thread T2 (block 1220), the process 1200 determines if the time (i.e., the clock value) associated with the last read is not earlier than (e.g., greater than or equal to) the time recorded for the T2 clock 716 in the T1 vector 704 (block 1222). If the time associated with the last read is not earlier than (e.g., greater than or equal to) the time recorded for the T2 clock 716 in the T1 vector 704, the process 1200 reports a data race condition on X between thread T1 and thread T2 (block 1224). In any event, if thread T1 writes data location X, the process 1200 records the fact that T1 wrote data location X and records the value of the T1 clock 706 in the T1 vector 704 as the time of the write (block 1226).

Although the above discloses example systems including, among other components, software executed on hardware, it should be noted that such systems are merely illustrative and should not be considered as limiting. For example, it is contemplated that any or all of the disclosed hardware and software components could be embodied exclusively in dedicated hardware, exclusively in software, exclusively in firmware or in some combination of hardware, firmware and/or software.

In addition, although certain apparatus have been described herein, the scope of coverage of this patent is not limited thereto. On the contrary, this patent covers all apparatuses, methods and articles of manufacture fairly falling within the scope of the appended claims either literally or under the doctrine of equivalents.

1. A method of handling a data race condition in a message-based multithreaded program, the method comprising:
storing a logical clock vector associated with a first processing thread;
saving data indicative of an access time at which a memory location is accessed by a second processing thread; and
reporting a data race condition.

2. A method as defined in claim 1, wherein reporting a data race condition comprises reporting the data race condition if a last write time of the memory location by the second thread is not earlier than a clock value for the second processing thread stored in the logical clock vector.

3. A method as defined in claim 1, wherein reporting a data race condition comprises reporting the data race condition if a last read time of the memory location by the second thread is not earlier than a clock value for the second processing thread stored in the logical clock vector.

4. A method as defined in claim 1, wherein reporting a data race condition comprises reporting the data race condition if (i) a last read time of the memory location by the second thread is not earlier than a clock value for the second processing thread stored in the logical clock vector and (ii) the first processing thread is writing to the memory location.

5. An apparatus for handling a data race condition, the apparatus comprising:
a thread creation monitor to determine when a first thread spawns a second thread; and
a logical clock initializer to (i) advance a first clock value in a first clock vector in response to a signal from the thread creation monitor indicative of the second thread being spawned, the first clock value being associated with the first thread, and (ii) initialize a second clock value in the first clock vector in response to the signal from the thread creation monitor indicative of the second thread being spawned, the second clock value being associated with the second thread, and (iii) create a second clock vector and set the second clock vector equal to the first clock vector in response to the signal from the thread creation monitor being indicative of the second thread being spawned, the second clock vector being associated with the second thread, and (iv) advance a third clock value in the second clock vector in response to the signal from the thread creation monitor being indicative of the second thread being spawned, the third clock value being associated with the second thread.

6. An apparatus as defined in claim 5, further comprising a message sending interceptor to:
advance the first clock value in the first clock vector;
copy the first clock vector to a memory location having an address;
construct a message envelope to include a message header, a message, and the address; and
send the message envelope from the first thread to the second thread.

7. An apparatus as defined in claim 6, further comprising a message receiving interceptor to:
receive the message envelope at the second thread;
disassemble the message envelope to recover the message and the address; and
synchronize the first clock vector with a third clock vector stored at the address.

8. An apparatus as defined in claim 7, wherein the apparatus assembles a reply envelope if the message is a synchronous message.

9. An apparatus as defined in claim 8, wherein the apparatus receives the reply envelope.

10. An apparatus as defined in claim 7, further comprising a data access tracer and a race detector, the data access tracer and the race detector cooperating to:
store the logical clock vector associated with the first thread;
save data indicative of an access time associated with a memory location by the second processing thread; and
report a data race condition based on a last access time associated with the memory location and the first clock vector.

11. A machine readable medium structured to cause a machine to:
store a logical clock vector associated with a first processing thread;
save data indicative of an access time associated with a memory location by a second processing thread; and
report a data race condition.

12. A machine readable medium as defined in claim 11, further structured to cause the machine to report the data race condition by reporting the data race condition if a last write time of the memory location by the second thread is not earlier than a clock value for the second processing thread stored in the logical clock vector.

13. A machine readable medium as defined in claim 11, further structured to cause the machine to report the data race condition by reporting the data race condition if (i) a last read time of the memory location by the second thread is not earlier than a clock value for the second processing thread stored in the logical clock vector and (ii) the first processing thread is writing to the memory location.

14. An apparatus comprising:
a processor; and
a random access memory (RAM) operatively coupled to the processor;
wherein the processor:
stores a logical clock vector associated with a first processing thread in the RAM;
saves data indicative of an access time at which a memory location is accessed by a second processing thread in the RAM; and
reports a data race condition.

15. An apparatus as defined in claim 14, wherein reporting a data race condition comprises reporting the data race condition if a last access time of the memory location by the second thread is not earlier than a clock value for the second processing thread stored in the logical clock vector.

16. An apparatus as defined in claim 15, wherein the access time comprises a read time.

17. An apparatus as defined in claim 15, wherein the access time comprises a write time.

18. A method of initializing a logical clock vector, the method comprising:
creating a second processing thread in a message-based multithreaded computing system in response to executing an instruction in a first processing thread;
advancing a first clock value in a first clock vector in response to creating the second processing thread, the first clock value and the first clock vector being associated with the first processing thread; and
initializing a second clock value in the first clock vector in response to creating the second processing thread, the second clock value being associated with the second processing thread.

19. A method as defined in claim 18, further comprising creating a second clock vector and setting the second clock vector equal to the first clock vector.

20. A method as defined in claim 19, further comprising advancing a third clock value in the second clock vector, the third clock value being associated with the second processing thread, the second clock vector being associated with the second processing thread.

21. A method of sending a first message in a message-based multithreaded computing system, the method comprising:
advancing a first clock value in a first clock vector;
copying the first clock vector to a memory location having an address;
constructing a message envelope to include a message header, the first message, and the address; and
sending the message envelope from a first processing thread to a second processing thread.

22. A method as defined in claim 21, further comprising intercepting the first message before the first message is sent to the second processing thread.

23. A method as defined in claim 21, wherein constructing the message envelope comprises constructing the message envelope to include a sending thread identifier if the first message is to be sent from the first processing thread to the second processing thread synchronously.

24. A method as defined in claim 23, wherein constructing the message envelope comprises constructing the message envelope without a sending thread identifier if the first message is to be sent from the first processing thread to the second processing thread asynchronously.

25. A method as defined in claim 23, further comprising:
receiving a reply message envelope at the first processing thread from the second processing thread, the reply message envelope including an address of a second clock vector; and
copying a clock value from the second clock vector to the first clock vector in response to receiving the reply message envelope.

26. A method of receiving a message in a message-based multithreaded computing system, the method comprising:
receiving a message envelope at a first processing thread from a second processing thread;
disassembling the message envelope to recover the message and data indicative of a second clock vector; and
synchronizing the first clock vector with a second clock vector.

27. A method as defined in claim 26, wherein the data indicative of the second clock vector comprises a pointer to the second clock vector.

28. A method as defined in claim 26, wherein the data indicative of the second clock vector comprises a pointer to a copy of the second clock vector.

29. A method as defined in claim 26, wherein the data indicative of the second clock vector comprises the second clock vector.

30. A method as defined in claim 26, further comprising assembling a reply envelope if the message is a synchronous message.

31. A method as defined in claim 30, wherein assembling the reply envelope comprises assembling a reply message and data indicative of a second clock vector.
